(19) United States
(12) Patent Application Publication
(10) Pub. No.: US 2019/0065589 A1
(43) Pub. Date: Feb. 28, 2019

(54) SYSTEMS AND METHODS FOR MULTI-MODAL AUTOMATED CATEGORIZATION

(71) Applicant: Quad Analytix LLC, San Mateo, CA (US)

(72) Inventors: He Wen, Menlo Park, CA (US); Yuchun Li, Santa Clara, CA (US); Nikhil Naole, Santa Clara, CA (US); Eric Chuk, Millbrae, CA (US); Carl-Francis A. Deguzman, San Francisco, CA (US); Ankur Jain, Sunnyvale, CA (US); Xiaoqin Zhou, Redwood City, CA (US); Ravi Mirchandaney, Menlo Park, CA (US); Anurag Bhardwaj, Sunnyvale, CA (US); Eric Kobe, San Mateo, CA (US); Sreenivasan Iyer, San Ramon, CA (US)

(21) Appl. No.: 16/087,412

(22) PCT Filed: Mar. 24, 2017
(86) PCT No.: PCT/US2017/024026

§ 371 Date: Sep. 21, 2018

Related U.S. Application Data
(60) Provisional application No. 62/313,525, filed on Mar. 25, 2016.

(51) Int. Cl. G06F 17/30; G06K 9/62; G06N 7/00

(52) U.S. Cl. CPC G06F 17/30707; G06F 17/3069; G06N 7/005; G06K 9/6293; G06F 17/30864

(57) ABSTRACT

Methods, systems, and apparatus, including computer programs encoded on a computer storage medium, for categorizing items presented on webpages. An example method includes: extracting text and an image from a webpage including an item to be categorized; providing the text as input to at least one text classifier; providing the image as input to at least one image classifier; receiving at least one first score as output from the at least one text classifier, the at least one first score including a first predicted category for the item; receiving at least one second score as output from the at least one image classifier, the at least one second score including a second predicted category for the item; and combining the at least one first score and the at least one second score to determine a final predicted category for the item.

### CROSS-REFERENCE TO RELATED APPLICATIONS

This application claims priority to U.S. Provisional Patent Application No. 62/313,525, filed Mar. 25, 2016, the entire contents of which are incorporated by reference herein.

### BACKGROUND

This specification relates to improvements in computer functionality and, in particular, to improved computer-implemented systems and methods for automatically categorizing or classifying items presented on webpages.

Large-scale categorization of products, services, and other items shown or described online is an open yet important problem in the machine learning community. A number of techniques can be used to address the problem and can be grouped into two buckets: rule based classification and learning based classification. Rule based classification systems can use a hierarchy of simple and complex rules for classifying items into categories. These systems are generally simpler to implement and can be highly accurate, but the systems are generally not scalable to maintain across a large number of categories. Learning based systems can use machine learning techniques for classification.

### SUMMARY

In certain examples, the subject matter described herein relates to a framework for large-scale multimodal automated categorization of items presented and/or described online. The items can be or include, for example, people, places, brands, companies, products, services, promotion types, and/or product attributes (e.g., height, width, color, and/or weight). Unlike existing techniques for categorization, the framework integrates webpage content (e.g., text and/or images) with webpage navigational properties to attain superior performance over a large number of categories.

In preferred implementations, the systems and methods described herein can perform classification based on a plurality of different signals, including, for example, webpage text, images, and website structure or category organization. For text classification, the systems and methods can use one or more classifiers, for example, in the form of a Bag-of-Words (BoW) based word representation and a word vector embedding (e.g., WORD2VEC) based representation. Text classification can use as input titles and descriptions for items, as well as product breadcrumbs present on webpages for the items. For image classification, the systems and methods can use an image classifier, for example, an 8-layer Convolution Neural Network (CNN), that receives as input images of the items from the webpages. A classifier fusion strategy can be used to combine the results text classification and the image classification results and generate a content likelihood of the item belonging to a specific category (e.g., that the item belongs to women's hats). To exploit latent category organization provided by website operators or owners (e.g., merchants for product webpages), the systems and methods can use crawl graph properties of webpages to estimate a probability distribution for item categories associated with the webpages. To address issues associated with a scarcity of labeled data or a lack of accurate webpage text, an unsupervised as well as a semi-supervised model can be used to compute this prior probability distribution. The probability distributions can be combined with content likelihood (e.g., in a Bayesian model) to yield a holistic categorization output.

In general, one aspect of the subject matter described in this specification relates to a computer-implemented method. The method includes: extracting text and an image from a webpage including an item to be categorized; providing the text as input to at least one text classifier; providing the image as input to at least one image classifier; receiving at least one first score as output from the at least one text classifier, the at least one first score including a first predicted category for the item; receiving at least one second score as output from the at least one image classifier, the at least one second score including a second predicted category for the item; and combining the at least one first score and the at least one second score to determine a final predicted category for the item.

In various implementations, the text includes at least one of a title, a description, and a breadcrumb for the item. The item can include, for example, a product, a service, a person, and/or a place. The at least one text classifier can include or use a bag of words classifier and/or a word-to-vector classifier. The at least one image classifier can include or use convolutional neural networks. Combining the at least one first score and the at least one second score can include: determining weights for the at least one first score and the at least one second score; and aggregating the at least one first score and the at least one second score using the weights.

In certain examples, the method includes: identifying a plurality of categories for a shelf page linked to the webpage; and determining a probability for each category in the plurality of categories, the probability including a likelihood that the shelf page includes an item from the category. Identifying the plurality of categories can include determining a crawl graph for at least a portion of a website that includes the webpage. Determining the probabilities can include using an unsupervised model and/or a semi-supervised model. In some implementations, the method includes: providing the final predicted category and the probabilities as input to a re-scoring module; and receiving from the re-scoring module an adjusted predicted category for the item.

In another aspect, the subject matter of this disclosure relates to a system having a data processing apparatus programmed to perform operations for categorizing online items. The operations include: extracting text and an image from a webpage including an item to be categorized; providing the text as input to at least one text classifier; providing the image as input to at least one image classifier; receiving at least one first score as output from the at least one text classifier, the at least one first score including a first predicted category for the item; receiving at least one second score as output from the at least one image classifier, the at least one second score including a second predicted category for the item; and combining the at least one first score and the at least one second score to determine a final predicted category for the item.

In various implementations, the text includes at least one of a title, a description, and a breadcrumb for the item. The item can include, for example, a product, a service, a person, and/or a place. The at least one text classifier can include or use a bag of words classifier and/or a word-to-vector classifier. The at least one image classifier can include or use convolutional neural networks. Combining the at least one first score and the at least one second score can include: determining weights for the at least one first score and the at least one second score; and aggregating the at least one first score and the at least one second score using the weights.

In certain examples, the operations include: identifying a plurality of categories for a shelf page linked to the webpage; and determining a probability for each category in the plurality of categories, the probability including a likelihood that the shelf page includes an item from the category. Identifying the plurality of categories can include determining a crawl graph for at least a portion of a website that includes the webpage. Determining the probabilities can include using an unsupervised model and/or a semi-supervised model. In some implementations, the operations include: providing the final predicted category and the probabilities as input to a re-scoring module; and receiving from the re-scoring module an adjusted predicted category for the item.

In another aspect, the invention relates to a non-transitory computer storage medium having instructions stored thereon that, when executed by data processing apparatus, cause the data processing apparatus to perform operations for categorizing online items. The operations include: extracting text and an image from a webpage including an item to be categorized; providing the text as input to at least one text classifier; providing the image as input to at least one image classifier; receiving at least one first score as output from the at least one text classifier, the at least one first score including a first predicted category for the item; receiving at least one second score as output from the at least one image classifier, the at least one second score including a second predicted category for the item; and combining the at least one first score and the at least one second score to determine a final predicted category for the item.

In various implementations, the text includes at least one of a title, a description, and a breadcrumb for the item. The item can include, for example, a product, a service, a person, and/or a place. The at least one text classifier can include or use a bag of words classifier and/or a word-to-vector classifier. The at least one image classifier can include or use convolutional neural networks. Combining the at least one first score and the at least one second score can include: determining weights for the at least one first score and the at least one second score; and aggregating the at least one first score and the at least one second score using the weights.

In certain examples, the operations include: identifying a plurality of categories for a shelf page linked to the webpage; and determining a probability for each category in the plurality of categories, the probability including a likelihood that the shelf page includes an item from the category. Identifying the plurality of categories can include determining a crawl graph for at least a portion of a website that includes the webpage. Determining the probabilities can include using an unsupervised model and/or a semi-supervised model. In some implementations, the operations include: providing the final predicted category and the probabilities as input to a re-scoring module; and receiving from the re-scoring module an adjusted predicted category for the item.

Elements of examples or embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example system for categorizing items on webpages.

FIG. 2 is a schematic diagram of an example webpage content module for categorizing a webpage item, based on text and/or an image on the webpage.

FIG. 3 is a schematic diagram illustrating an example method of using a webpage content module to categorize an item on a webpage.

FIG. 4 is a schematic diagram illustrating an example method of using a word-to-vector classifier to categorize an item on a webpage.

FIG. 5 is a schematic diagram of a crawl graph showing the structure of a website.

FIG. 6 is a schematic diagram of an example navigational prior module for determining a distribution of categories associated with a shelf page of a website.

FIG. 7 is a schematic diagram of an example of semi-supervised model for determining a navigational prior.

FIG. 8A is a schematic diagram illustrating an example method of using a webpage content module to categorize an item on a webpage.

FIG. 8B is a screenshot of an example shelf page on a website.

FIG. 8C is a schematic diagram illustrating an example method of using a re-scoring module to categorize an item on a webpage.

FIG. 9 includes images of two items that look similar but belong in different categories, in accordance with certain examples of this disclosure.

FIG. 10 is a plot of precision versus recall rate for a set of experiments performed using certain examples of the item categorization systems and methods described herein.

FIG. 11 is a flowchart of an example method of categorizing an item presented on a webpage.

### DETAILED DESCRIPTION

It is contemplated that apparatus, systems, and methods embodying the subject matter described herein encompass variations and adaptations developed using information from the examples described herein. Adaptation and/or modification of the apparatus, systems, and methods described herein may be performed by those of ordinary skill in the relevant art.

Throughout the description, where apparatus and systems are described as having, including, or comprising specific components, or where processes and methods are described as having, including, or comprising specific steps, it is contemplated that, additionally, there are apparatus and systems of the present invention that consist essentially of, or consist of, the recited components, and that there are processes and methods according to the present invention that consist essentially of, or consist of, the recited processing steps.

Examples of the systems and methods described herein are used to categorize or classify items described, accessed, or otherwise made available on the Internet or other network. While many of the examples described herein relate specifically to categorizing products, it is understood that the systems and methods apply equally to categorizing other items, such as services, people, places, brands, companies, and the like.

As described herein, the systems and methods can utilize one or more classifiers or other predictive models to categorize items. The classifiers may be or include, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests), neural networks, and/or learning vector quantization models. Other predictive models can be used. Further, while the examples presented herein can describe the use of specific classifiers for performing certain tasks, other classifiers may be able to be substituted for the specific classifiers recited.

Large-scale categorization of items shown or described online is an open yet important problem in the machine learning community. One of the most significant real-world applications of this problem can be found in eCommerce domains, where categorizing product pages into an existing product taxonomy has a multitude of use cases ranging from search to user experience. Additionally, having the ability to classify any product from a number of different merchant-specific taxonomies into a canonical eCommerce taxonomy opens up avenues for novel insights. A number of techniques can be used to address this issue from a classification perspective. These can be grouped into two buckets: rule based classification and learning based classification.

Rule based classification systems can use a hierarchy of simple and complex rules for classifying products, services, or other items into item categories. These systems are generally simpler to implement and can be highly accurate, but the systems are generally not scalable to maintain across a large number of item categories. In some examples, a variant of a rule based system can identify context from text using, for example, synonyms from the hypernymy, hyponymy, meronymy and holonymy of one or more words, to map to taxonomies. In some instances, a lexical database (e.g., WORDNET) can be leveraged for this purpose.

Learning based systems can use machine learning techniques for classification. In one example, a Naive Bayes classifier and/or K-Nearest Neighbors (KNN) can be used on text, images, and other inputs. Alternatively or additionally, both machine learning and rules can be used for classification of text, images, or other inputs, in an effort to boost performance of learning based systems using rule based classifiers. In some instances, images contain important form or shape, texture, color and pattern information, which can be used for classification purposes, in addition to or instead of text. Moreover, webpage owners and operators (e.g., eCommerce merchants) often organize items according to a local taxonomy, which can be a strong signal for the task of classification. For example, a webpage for a product may indicate that the product belongs in a “women's shirts” category, which falls within a “women's apparel” category or an even broader “apparel” category.

In various examples, the systems and methods described herein combine webpage content with webpage navigational properties to yield a robust classification output that can be used for large-scale, automated item classification. In general, a classification system built on top of a multitude of signals or data types derived from webpages is likely to be more accurate than one built with only one signal or data type. A given webpage, for example, can contain a number of signals for the item, such as a title, a description, a breadcrumb (e.g., an indication of a relationship or connection between the webpage and its parent pages), a thumbnail or other image, and a recommendation (e.g., a product review and/or a recommendation for a related product). As such, it can be important to discriminate which of these signals is likely to be more relevant for the task of item classification. Title and thumbnail are usually good representations of the item itself and hence can carry a lot of information for classification tasks. Additionally or alternatively, a breadcrumb can denote a classification label for the item based on the website's specific taxonomy, hence the breadcrumb can provide useful classification information. A webpage for a women's backpack, for example, could include the following breadcrumb “luggage >backpacks >adult backpacks.” Item description and recommendation on the other hand are generally unstructured and may contain noise that can adversely influence the classification performance. In preferred implementations, the systems and methods described herein utilize three content signals in the form of title, breadcrumb, and thumbnail for the classification task.

Given the variety of website categories, layouts, and designs, there can be a large variation among the quality of content present on webpages. Website owners and operators typically organize pages belonging to the same or closely related categories in a single category level, referred in some examples as a “shelf page” or simply as a “shelf” These shelf pages can be represented in a crawl graph as a parent node that provides access to multiple webpages for related or similar items. For example, a shelf page related to women's shoes could provide access to multiple webpages related to women's shoes. Additionally or alternatively, a webpage related to women's shoes could be accessed from a shelf page related generally to shoes, which can include or have information related to men's, women's, and/or kid's shoes. As such, webpages accessible from the same shelf page usually fall within the same or similar category and/or can define a similar category distribution. Hence, implementations of the systems and methods can utilize a holistic approach that combines multiple modalities of a webpage.

In general, to derive novel insights from item classification, such as product assortment or pricing analysis, the classification accuracy should be high. For example, comparing the assortments of products and/or matching products (e.g., a certain coffee) offered by two or more online merchants (e.g., WALMART and TARGET) is generally not possible without first performing an accurate classification. Successful classification provides a basis for further analyses to be performed, since the classification can provide facts related to items in retailers' inventories. Examples of the systems and methods described herein can use a combination of algorithmic classification and crowd annotation or crowd sourcing to achieve improved accuracy. In various implementations, the classification results from multiple modalities or classifiers are combined in a fusion algorithm, which determines a classification outcome and an accuracy confidence level. When the confidence level is determined to be low, the classification task can be sent to crowd members for further processing (e.g., re-classification or verification). When the confidence level is determined to be high, a smaller percentage (e.g., 5%, 10%, or 20%) of the classification tasks can be verified and/or adjusted through the crowd, in an effort to improve classification accuracy.

In preferred examples, the crowd members have intimate knowledge and familiarity with the taxonomy used by the systems and methods. Annotation from crowd members can serve as a benchmark for classification accuracy. In general, a goal of the systems and methods is to build a high precision classification system (e.g., a system that is confident when a correct classification is achieved), such that crowd members can be looped in, as appropriate, when the classification system does not provide an answer or is not confident in the answer.

Alternatively or additionally, the systems and methods described herein can be used for taxonomy development. Almost all eCommerce merchants and retailers, for example, have a unique taxonomy that is usually built based on a size and focus of a merchandising space. To classify an online item from an arbitrary website, an in-house and/or comprehensive canonical taxonomy can be developed. For products and services, the scale and granularity of the taxonomy can be comparable to taxonomies used by large merchants, such as WALMART, AMAZON, and GOOGLE SHOPPING. Top-level nodes of the taxonomy can include macro-categories, such as home, furniture, apparel, jewelry, etc. The leaf-level nodes of the taxonomy can include micro-categories, such as coffee maker, dining table, women's jeans, and watches, etc.

In preferred implementations, when a webpage is extracted from or identified on a website, the webpage or corresponding item (e.g., product or service) can be mapped onto a leaf-level node of the taxonomy. Although some items with multiple functionality and usability could be mapped onto multiple leaf-level nodes, the systems and methods preferably focus on single node classification at the leaf level. In this case, the webpage or corresponding item can be mapped onto the semantically closest node. For example, a webpage related to a “rain jacket” could be mapped to an existing “rain coat” category in the taxonomy. This allows existing categories to be used, if appropriate, and avoids the creation of multiple categories for the same items.

Implementations of the systems and methods described herein can use or include a framework for capturing category level information from a crawl graph or arrangement of pages available on a website. For example, two or more models can be used to compute a navigational prior for each product page available on the website. Additionally or alternatively, the systems and methods can use or include a multi-modal approach to classification that can utilize a plurality of information or content signals available on a webpage. For example, inputs to one or more classifiers can include a title, a breadcrumb, and a thumbnail image. Classifier outputs can be combined using a score fusion technique. In some examples, a Bayesian Re-scoring formulation is used to improve overall classification performance by combining information derived from or related to the navigational prior and the webpage content.

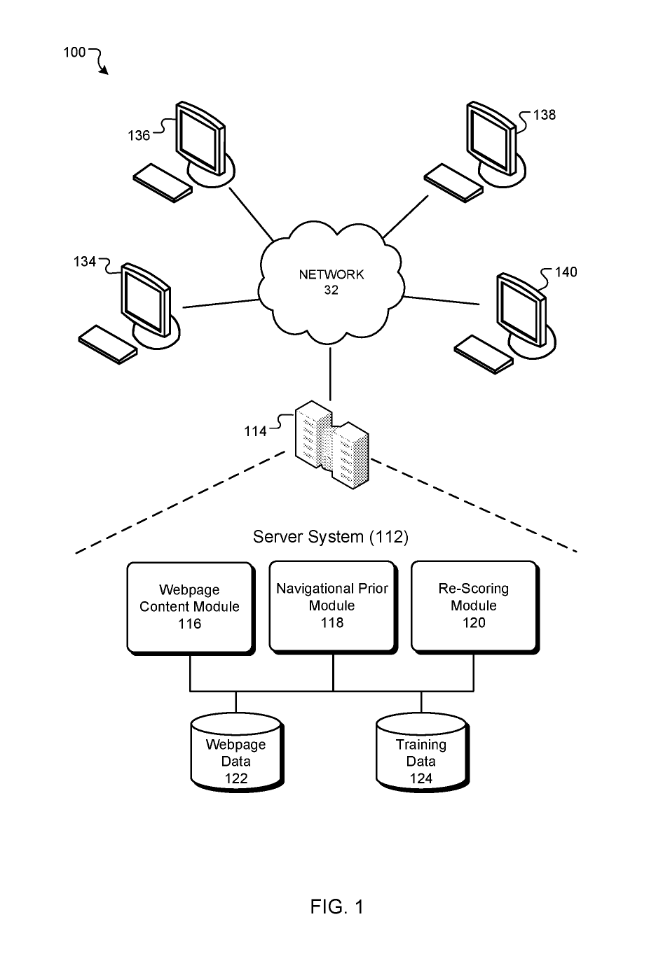

FIG. 1 illustrates an example system 100 for automatic categorization of items described or shown on webpages, including products, services, people, places, brands, companies, promotions, and/or product attributes (e.g., height, width, color, and/or weight). A server system 112 provides data retrieval, item categorization, and system monitoring. The server system 112 includes one or more processors 114, software components, and databases that can be deployed at various geographic locations or data centers. The server system 112 software components include a webpage content module 116, a navigational prior module 118, and a re-scoring module 120. The software components can include subcomponents that can execute on the same or on different individual data processing apparatus. The server system 112 databases include webpage data 122 and training data 124. The databases can reside in one or more physical storage systems. The software components and data will be further described below.

An application having a graphical user interface can be provided as an end-user application to allow users to exchange information with the server system 112. The end-user application can be accessed through a network 32 (e.g., the Internet and/or a local network) by users of client devices 134, 136, 138, and 140. Each client device 134, 136, 138, and 140 may be, for example, a personal computer, a smart phone, a tablet computer, or a laptop computer. In various examples, the client devices 134, 136, 138, and 140 are used to access the systems and methods described herein, to categorize products, services, and other items described or made available online.

Although FIG. 1 depicts the navigational prior module 118, the webpage content module 116, and the re-scoring module 120 as being connected to the databases (i.e., webpage data 122 and training data 124), the navigational prior module 118, the webpage content module 116, and/or the re-scoring module 120 are not necessarily connected to one or both of the databases. In general, the webpage content module 116 is used to process text and images on a webpage and determine a category associated with one or more items on the webpage. For example, the webpage content module 116 can extract the text and images (e.g., a title, a description, a breadcrumb, and a thumbnail image) from a webpage, provide the text and images to one or more classifiers, and use the classifier output to determine a category (e.g., backpacks) for an item on the webpage.

In general, the navigational prior module 118 is used to determine a distribution of categories associated with shelf pages that show or describe individual items (e.g., products) and/or provide access to webpages for the individual items. For a product shelf page, for example, the navigational prior module 118 can determine that 20% of the products described in the shelf page are shoes, 40% of the products are shirts, 30% of the products are pants, and 10% of the products are socks.

The re-scoring module 120 is generally used to combine information used or generated by the navigational prior module 118 and the webpage content module 116 to obtain more accurate category predictions. The re-scoring module 120 can use one or more classifiers for this purpose.

In various implementations, the webpage data 122 and the training data 124 can store information used and/or generated by the navigational prior module 118, the webpage content module 116, and/or the re-scoring module 120. For example, the webpage data 122 can store information related to webpages processed by the system 100, such as webpage layout, content, and/or categories. The training data 124 can store data used to train one or more system classifiers.

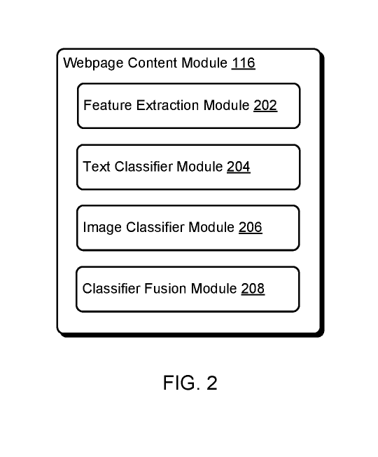

Referring to FIG. 2, the webpage content module 116 can include a feature extraction module 202 that extracts text (e.g., a title, a breadcrumb, or a description) and/or one or more images (e.g., a thumbnail image) from the webpage. In various implementations, the feature extraction module 202 uses a tag-based approach for feature extraction on product pages and other webpages. The feature extraction module 202 can use, for example, HTML tags to identify where elements are located based on annotations in a page source. The HTML tags can be curated manually in some instances.

In one example, the feature extraction module 202 can use a pruning operation to identify candidate elements on a webpage that may include information of interest (e.g., a title or a breadcrumb). A set of features can be extracted from the candidate elements, and the features can be input into a trained classifier to obtain a final determination of the webpage elements that include the information of interest. Additional feature extraction techniques are possible and can be used by the feature extraction module 202. For example, possible feature extraction techniques are described in U.S. patent application Ser. No. 15/373,261, filed Dec. 8, 2016, titled “Systems and Methods for Web Page Layout Detection,” the entire contents of which are incorporated herein by reference.

The webpage content module 116 can include a text classifier module 204 that includes one or more text classifiers. The text classifier module 204 can receive as input text extracted from the webpage using the feature extraction module 202. The text classifier module 204 can process the extracted text and provide as output a predicted category associated with an item on the webpage. For example, output from the text classifier module 204 can include a predicted category for a product described on the webpage and a confidence score associated with the prediction. Alternatively or additionally, the webpage content module 116 can include an image classifier module 206 that includes one or more image classifiers. The image classifier module 206 can receive as input one or more images extracted from the webpage using the feature extraction module 202. The image classifier module 206 can process the extracted image(s) and provide as output a predicted category associated with an item on the webpage. For example, output from the image classifier module 206 can include a predicted category for a product described on the webpage and a confidence score associated with the prediction. In preferred implementations, the webpage content module 116 includes a classifier fusion module 208 that combines output from two or more classifiers associated with the text classifier module 204 and/or the image classifier module 206. The combined output can include a predicted category and a confidence score for the item on the webpage. The category prediction obtained from the classifier fusion module 208 is generally more accurate than the prediction obtained from either the text classifier module 204 or the image classifier module 206 alone.

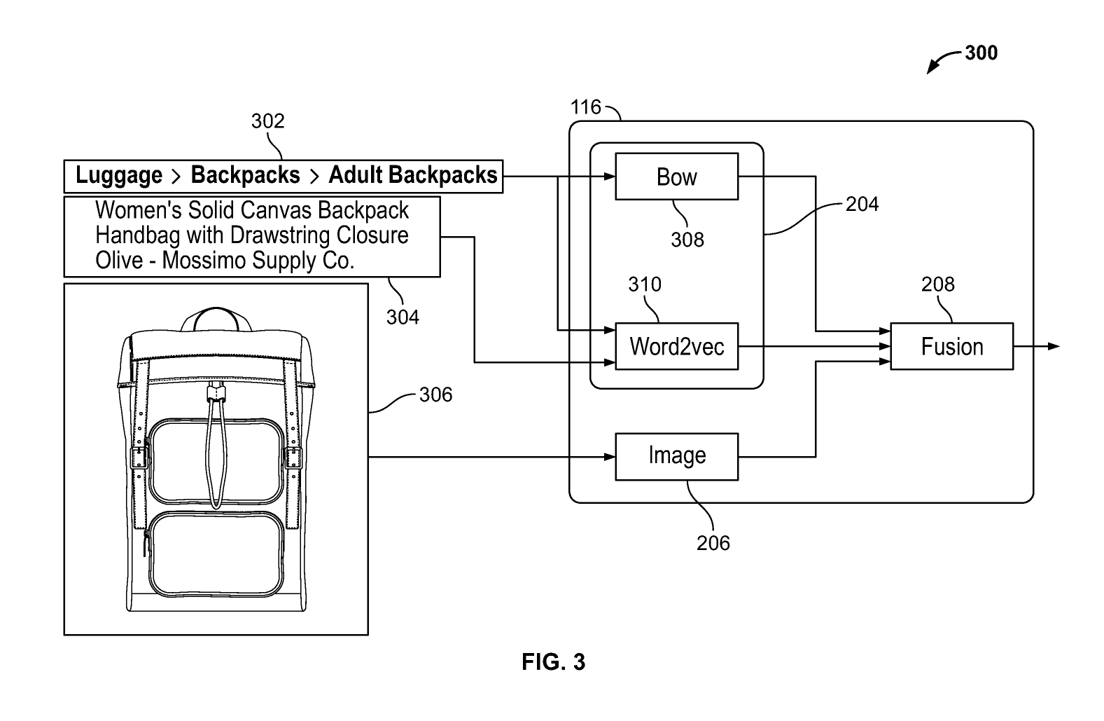

FIG. 3 illustrates an example method 300 of using the webpage content module 116 to classify an item on a webpage. The feature extraction module 202 is used to extract a breadcrumb 302, a title 304, and an image 306 from the webpage. The breadcrumb 302 and title 304 are provided as inputs to the text classifier module 204 and the image 306 is provided as an input to the image classifier module 206. In the depicted example, the text classifier module 204 includes a bag of words (BoW) classifier 308 and a word-to-vector classifier 310. The outputs from the text classifier module 204 and the image classifier module 206 are then processed with the classifier fusion module 208 to obtain a final categorization for the item.

For the BoW classifier 308, training data can be collected in the form of item titles or other text for each a group of categories C and stored in the training data 124. In one example, one classifier is trained for every category c within the group of categories C, such that training data from a category c contributes to positive samples of the classifier and training data from other categories contributes to negative samples of the classifier. Each category c can have a training file with p lines with label-1 (one for each product title belonging to category c) and n lines with label-0 (one for each product title not belonging to category c). Each line or product title can first be tokenized into constituent tokens after some basic text processing (e.g., case normalization, punctuation removal, and/or space tokenization), followed by stop word removal and/or stemming. Tokens from all lines in the training file can be grouped together to create a dictionary of vocabulary of words. To reduce the size of the dictionary, a word count threshold K of can be used to select only those words in the vocabulary that have occurred at least K times in the training file. Post dictionary construction, each line of the file can be processed again so that, for each line of the training file or product title, an empty vector of size D can be created, where D is a total number of unique words in the constructed dictionary. Each token in the title can be taken and its index (e.g., a number between 0 and D) in the dictionary can be searched through a hash-based lookup. Upon finding the token in dictionary at an index I, the vector can be modified to increment its count by 1 at the index I. This process can be repeated until all tokens on one line are exhausted. The resultant vector may now be a BoW-encoded vector. This process can be repeated for all lines in the training file. Finally, p+n BoW vectors along with corresponding labels can input to a support vector machine (SVM) model that is trained using a kernel, which is preferably linear due to a large dimensionality of the vector and a sparse nature of the vector (e.g., only few entries in the vector may be non-zero). A similar process can be employed for all categories, resulting in C trained classifiers at the end of this process. During testing of the BoW classifier 308, a majority voting criterion can be used to pick the category with the most votes as the chosen category for the product title.

In some examples, the BoW representation can create a dictionary over all tokens (e.g., words) present in text and perform a 1−K hot-encoding. This can result, however, in prohibitively large dictionaries that can be inefficient for large-scale text classification. In preferred implementations, a feature hashing technique is used to avoid this issue. The feature hashing technique can use a kernel method to compare and hash any two given objects. A typical kernel k can be defined as:

k(xᵢ,xⱼ)= [symbol] ϕ(xᵢ),ϕ(xⱼ) [symbol] (1)

where φ(xi) represents features for a given string token xᵢ. This representation can be used to generate hashed features as follows:

ϕᵢ^{h,ε}(x)=Σ_{j:h(j)=i}ε(i)xᵢ (2)

and

[symbol]

x,x′ [symbol] _{ϕ}= [symbol] ϕ^{h,ε}(x),ϕ^{h,ε}(x′) [symbol] (3)

where h denotes the hash function h:N→1, . . . , m, and E denotes a hash function E:N→[−1, +1]. A similar process can be used for all categories, thereby resulting in C trained classifiers at the end of this training process. In a preferred implementation, majority voting criteria can be used to identify the category with the most votes as the chosen category for a given title or other text.

In preferred implementations, the word-to-vector classifier 310 includes or utilizes an unsupervised word vector embedding model (e.g., WORD2VEC) trained using the training data 124, which can include over 360 million word tokens extracted from over 1 million webpages. An unsupervised word vector-embedding model M can take a corpus of text documents and convert the text into a hash-like structure, where key can be a word token and value can be a K-dimensional vector. An interesting aspect of this model is that words that are similar to each other in linguistic space (e.g., walk, run, and stroll) generally have smaller Euclidean distances between their individual K-dimensional word vectors. Hence, the model aims to preserve the semantics of word tokens, which may not be possible for models like BoW, which may capture only frequency-based correlations between word tokens and not semantics. Statistically, each word vector can be trained to maximize log-likelihood of neighboring words w₁, w₂, . . . , w_{T} in a given corpus as:

$$\frac{1}{T} {\sum }_{t = 1}^{T} {\sum }_{j ∈ C ( j , t )} log P ( {w}_{t} \vert {w}_{j} ) \qquad ( 4 )$$

where C(j, t) defines a context or word-neighborhood function that is equal to 1 if word wⱼ and wₜ are in a neighborhood of k tokens, where k is a user-defined skip-gram parameter. In this process, each title or other text (e.g., breadcrumb or description) can be converted into its constituent tokens. For example, if a particular title has T tokens (e.g., words), each of these tokens can be looked up in the learn word vector model M and, if present, the model can return with a K-dimensional (e.g., 100, 200, or 300 elements) vector representation. At the end of this process, a matrix of size T×K is obtained that corresponds to T tokens, each having K-dimensional word vectors.

The T×K matrix can be converted into a fixed dimensional 1×K vector using, for example, an average pooling, a max pooling, or a Fisher vector pooling approach. With average pooling, the 1×K vector can be obtained by taking the mean of each of the K columns across all T rows. With max pooling, the 1×K vector can be obtained by taking the max of each of the K columns across all T rows. With Fisher vector pooling, the following transformation can be applied to obtain a 1×(2*K) vector:

$$\begin{matrix}\frac{\partial L ( X \vert λ )}{\partial {μ}_{d}} = {\sum }_{i = 1}^{N} \frac{{x}_{i , d} - {μ}_{d}}{{σ}_{d}^{2}} & ( 5 ) \\ \frac{\partial L ( X \vert λ )}{\partial {σ}_{d}} = {\sum }_{i = 1}^{N} ( \frac{{( {x}_{i , d} - {μ}_{d} )}^{2}}{{σ}_{d}^{3}} - \frac{1}{{σ}_{2 , d}} ) & ( 6 )\end{matrix}$$

This process can be repeated for every title, breadcrumb, or other text in a training set. Finally, for the Fisher vector pooling, a giant matrix of N×(2*K) can be generated (where N is the total number of product titles or other text descriptions in the training data) which can be input to a multi-class linear support vector machine (SVM) classifier or other suitable classifier. Likewise, for the average pooling or max pooling approaches, an N×K matrix can be input to the SVM classifier. In one example, a single classifier can be trained across all categories in a taxonomy. Experiments suggest that the Fisher vector pooling approach outperforms other pooling techniques.

In certain examples, the word-to-vector classifier 310 can be trained across all C categories. The word-to-vector classifier 310 can be used to categorize different types of webpage text, including titles, descriptions, breadcrumbs, and combinations thereof.

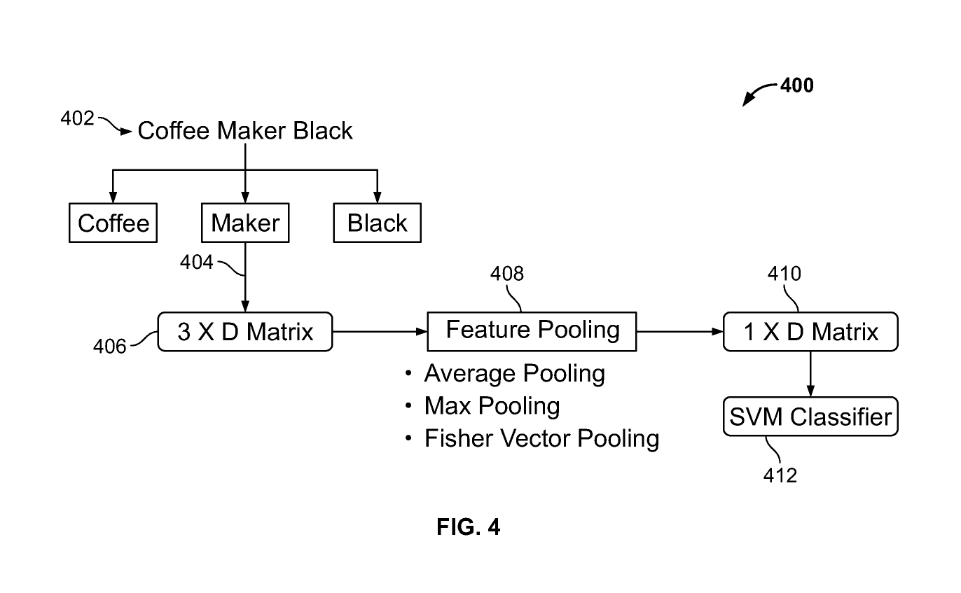

FIG. 4 is a schematic diagram of an example method 400 of using the word-to-vector classifier 310 to categorize a product based on a product title 402 obtained from a product webpage. In the depicted example, the title 402 includes three words (i.e., “coffee,” “maker,” and “black”), and each word is converted into a 1×D vector representation (e.g., using WORD2VEC), which can be combined at step 404 to form a 3×D matrix 406. The 3×D matrix can then be pooled (e.g., using average, max, of Fisher vector pooling) at step 408 to form a vector 410 that is input into a trained SVM classifier 412. The output from the SVM classifier 412 includes a predicted category for the item shown on the product webpage.

For the image classifier module 206, training a large-scale custom image classification system can require millions of images annotated by humans. Image classification models built on image data from IMAGENET show impressive accuracy, having benefited from a rich and accurate training dataset. Such publicly available annotated image data, however, can be insufficient to fully train the image classifier module 206. To address this issue, a preferred approach is to take an already learned model (e.g., ALEXNET) and fine-tune the learning with custom image data (e.g., from the eCommerce domain), based on already learned weights. Further, traditional models can be trained on broad eCommerce categories, such as shoes, which makes it harder to differentiate between fine-grained categories such as sneakers, shoes, boots, and sandals. In preferred examples, the image classifier module 206 utilizes Convolutional Neural Networks (ConvNet or CNN) filters that are trained or re-trained on fine-grained data, thereby generating image filters that are more discriminative for the task of fine-grained category classification. Since the fine-tuned model can adopt architecture from a pre-trained model, a deep ConvNets model (e.g., ALEXNET) can be used and further trained with fine-grained data, for example, from eCommerce. By fine-tuning the training on these learned filters, the filters can be refined or adapted to be more sensitive to the specific images that will be processed by the image classifier module 206. In one example, an input image is re-sized to 227×227 pixels. The image classifier module 206 can include a series of convolution and pooling layers that reduce an image to an activation volume of size 7×7×512. The image classifier module 206 can use two fully connected layers and a last fully connected layer of 459 neurons (e.g., when there are 459 classes in training set) to calculate a score of each class. Once trained, the image classifier module 206 can receive an image from a webpage as input and provides a predicted category and confidence score as output.

In general, the classifier fusion module 208 combines output from the text classifier module 204 and the image classifier module 206 to arrive at a more accurate category prediction. In one example, the classifier fusion module 208 uses a weighted score fusion based technique. Predictions from the BoW classifier 308, the word-to-vector classifier 310, and/or the image classifier module 206 can be aggregated in a weighted manner, where weights for each classifier represent a confidence level for the classifier. The weights can be learned through a linear regression framework, in which the dependent variable is a correct category and the independent variables are top candidates from each of the classifiers. At the end of regression, trained weights for each of the independent variables can be representative of the overall classifier weight to be used.

One drawback of score level classifier fusion can be score normalization. In general, each classifier is trained on its own set of training data and can have its own sensitivity and/or specificity. To avoid or minimize such bias, a z-score based normalization technique can be used. Another potential issue with classifier fusion relates to classifier precision and recall. A particular classifier may have high recall but low precision, and using a score level fusion with a high weight for such a classifier may lead to lower precision of the system.

Alternatively or additionally, the classifier fusion module 208 can use decision level classifier fusion, in which classifier scores can be ignored and predicted responses or labels can be used. With a majority voting decision level approach, top responses from each classifier can be obtained and can be computed for each label across all classifiers. Labels with highest votes can be output as a final choice of classifier combination system. This system in general performs well but can lead to biased results, for example, when there are three or more classifiers and at least two classifiers are sub-optimal. Sub-optimal classifiers can converge to a majority vote and final system performance can also be sub-optimal.

With a mutual agreement decision level approach, top results from all classifiers can be compared. If all classifiers agree on a final result, the final result can be returned as the combination output, otherwise no results may be returned by the system. As expected, the strategy can lead to lower recall but higher precision. An advantage of the approach is generally stable classification results, irrespective of using a combination of sub-optimal classifiers.

In some implementations, the classifier fusion module 208 uses the mutual agreement decision level approach. This allows the classifier fusion module 208 to output highly precise results, regardless of varying levels of accuracy for the constituent classifiers. In certain examples, the classifier fusion module 208 can combine output from the BoW classifier 308 and the word-to-vector classifier 310. Alternatively or additionally, the classifier fusion module 208 can combine output from the image classifier module 206 (e.g., a ConvNets Image Classifier) and the BoW classifier 308.

In alternative embodiments, the classifier fusion module 208 can use an additional classifier for combining the predictions from the text classifier module 204 and the image classifier module 206. For example, the additional classifier can receive as input the predictions from the text classifier module 204 and the image classifier module 206 and provide as output a combined prediction. The additional classifier can be trained using the training data 124.

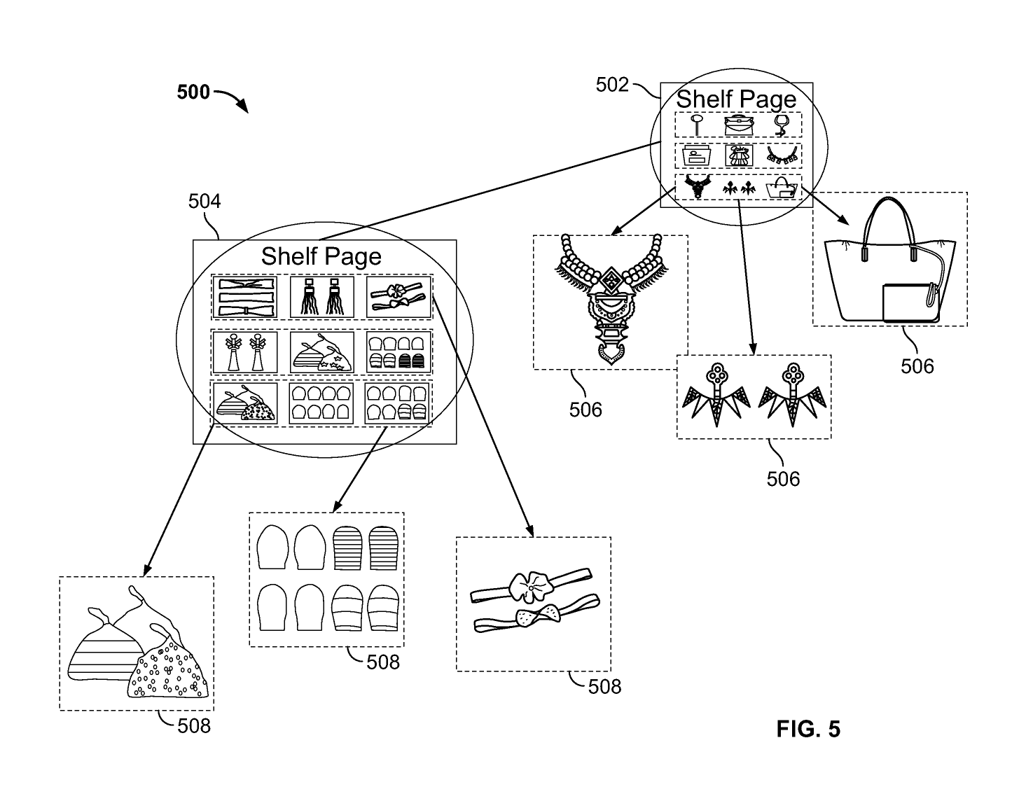

Referring to FIG. 5, in various examples, websites are organized in a tree-like structure or crawl graph 500 in which pages for individual items are accessed from shelf pages. In the depicted example, the crawl graph 500 includes an upper shelf page 502, a lower shelf page 504, an upper set of product pages 506, and a lower set of product pages 508. A user visiting the upper shelf page 502 is able to view a collection of products displayed on the page and can select links on the upper shelf page 502 that direct the user to the upper set of product pages 506. The upper shelf page 502 also includes a link that directs the user to the lower shelf page 504, where additional products can be viewed and links can be selected that direct the user to the lower set of product pages 508.

By determining the crawl graph and/or website structure, the navigational prior module 118 can analyze the content of any shelf pages and predict the categories for webpages that are accessed from the shelf pages. In general, product pages that share a common parent shelf page are associated with similar products and/or have a similar category distribution. The navigational prior module 118 can use the crawl graph information to eliminate any spurious category predictions based on other information, such as text or image information, which is not always clear or accurate. In preferred implementations, the systems and methods automatically classify the product pages for a particular shelf page and utilize the classification output to compute a holistic shelf level histogram that defines how likely it is that the shelf page contains products in particular categories. This histogram can be referred to as a “navigational prior.”

An example navigational prior for a shelf page is presented in Table 1, below. As the table indicates, the navigational prior includes a listing of item categories for the shelf page and a probability or likelihood that the shelf page includes or provides access to the categories (e.g., though a link to a webpage for an item in the category). The categories in this example relate to footwear, with the most likely category being dress shoes and the least likely category being socks.

TABLE 1
Example navigational prior for a shelf page.

| Item Category | Probability |
|---|---|
| Dress shoes | 30% |
| Casual shoes | 25% |
| Running shoes | 20% |
| Hiking boots/shoes | 18% |
| Slippers | 5% |
| Socks | 2% |

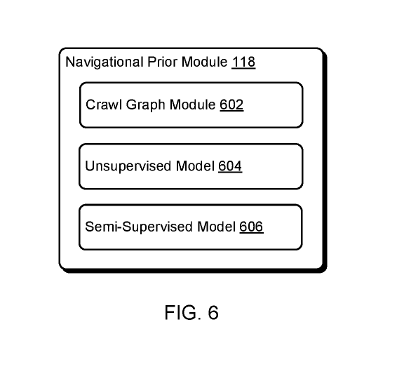

Referring to FIG. 6, in certain implementations, the navigational prior module 118 includes a crawl graph module 602, an unsupervised model 604, and a semi-supervised model 606. The crawl graph module 602 is configured to obtain or determine a crawl graph for a website (e.g., a merchant's website). To generate the crawl graph, the crawl graph module 602 can crawl or traverse a website to identify pages that relate to multiple items (e.g., shelf pages) and pages that relate to individual items (e.g., product pages). The approach can also determine relationships between the pages on the website. For example, a product page that can be accessed from a shelf page is generally considered to depend from or be related to the shelf page. In certain examples, merchants and other website owners or operators utilize a page address or uniform resource locator (URL) pattern that indicates whether the website pages are for individual items (e.g., product pages) or multiple items (e.g., shelf pages). For example, WALMART's URL structure for product pages can use https://www.walmart.com//ip/ . . . for product pages and/or can include “cat_id” for shelf pages, such as https://www.walmart.com/browse/clothing/women-s-shoes/5438_1045804_1045806?cat_id=5438_1045804_1045806_1228540. The crawl graph module 602 can recognize and utilize such URL structures to determine the types of webpages and generate the crawl graph.

With the crawl graph determined, the unsupervised model 604 and/or the supervised model can be used to determine category probabilities or navigational priors for shelf pages. In preferred implementations, the unsupervised model 604 uses a statistical model, such as Latent Dirichlet Allocation (LDA) (also referred to as a “topic model”) for this purpose, though other generative statistical models can be used. For example, top predictions (e.g., top 5 or 10 predictions) from raw classifiers (e.g., the text classifier module 204 and/or the image classifier module 206) can be fed to the classifier fusion module 208, which preferably aggregates predictions from the raw classifiers and generates top predictions (e.g., top 5 or 10 predictions), which can be input into the unsupervised model 604.

In general, LDA is a generative model that explains the process of generating words in a document corpus. In the unsupervised model 604, LDA can be used to explain or determine the process of generating item categories for the shelf pages in a website. Each shelf page can emit a particular category of a topic Z. In the context of topic model, the topic Z can be a grouping of input features. When input features are words, for example, the topic Z can be a grouping of words. Likewise, when input features are classifier predictions, the topic Z can be a grouping of predicted item categories. For each topic Z, a product d can be sampled and fed through a raw classification system (e.g., the webpage content module 116) that produces its top candidates W. More formally, the generative process can include the following steps:
1. Start with a random value of ξ and generate samples from a Poisson distribution seeded with the current value of ξ. From the generated samples, pick one value that is equal to N. In other words, select N˜ Poisson(ξ) where N and ξ are hyper parameters in the model.
2. Start with a random value of α and generate samples from a Dirichlet distribution seeded with the current value of α. From the generated samples, pick one value that is equal to θ. In other words select θ˜Dir(α), where θ is a distribution of categories for product d, and α is a parameter of the prior distribution over θ.
3. For each of top-N candidates for the product d:
   a. Start with a random value of θ and generate samples from a multinomial distribution seeded with the current value of θ. From the generated samples, pick one value that is equal to z. In other words, select a category z˜Multinomial(θ).
   b. Select a candidate wₙ from P(wₙ|zₙ, β) which is also a multinomial probability distribution. In this step, multiple samples can be generated from P(wₙ|zₙ, β), where each sample represents a value of w_{n.}
      Then, like an LDA model, the joint distribution of a shelf-category distribution θ, a set of N categories z and observed top-candidate w is given as:

P(θ,s,f)=P(θ|α)Πₙ₌₁^{N}P(zₙ|θ)P(wₙ|zₙ,β). (7)

Once the unsupervised model 604 has generated a probability distribution over all the K categories for each product in the shelf image, the distribution can be used as the navigational prior.

One of the drawbacks of a topic model based approach to determining the navigational prior is that noisy candidates from raw classification (e.g., the webpage content module 116) can lead to poor topic convergence. To alleviate this problem, the semi-supervised model 606 can be used to obtain human annotations, which can remove any spurious candidates and provide a higher quality navigational prior. However, a large scale human annotation may not be scalable and can lead to higher crowd costs.

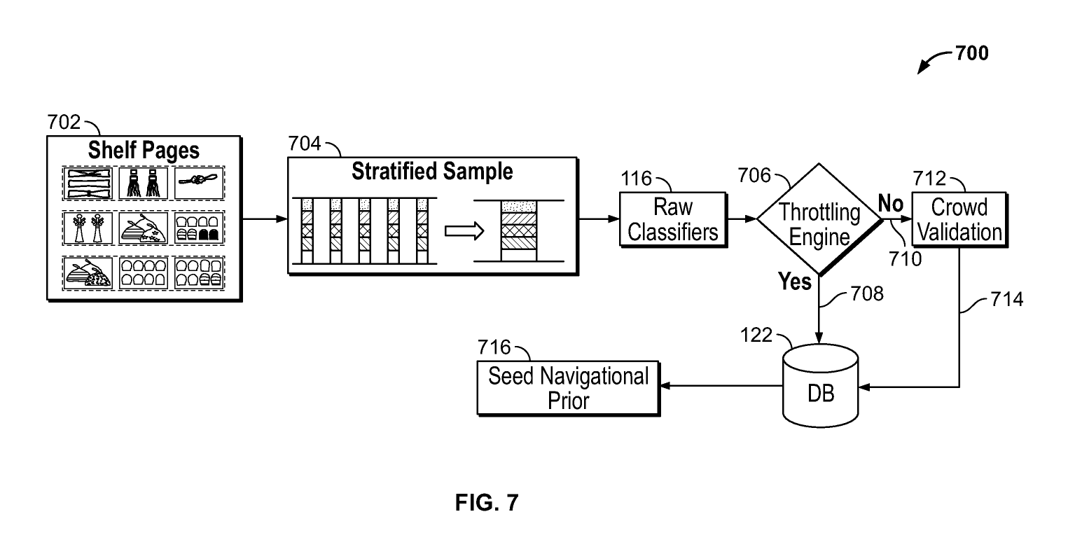

In preferred implementations, the semi-supervised model 606 employs the crowd intelligently by sending only a representative sample of product pages for human annotation. Referring to FIG. 7, in one example method 700, the sample can be generated by first running a partition function over the display order of all the products in a shelf page 702. The partition function can divide the shelf page into a number of portions (e.g., top left, top right, bottom left, and bottom right quadrants), and one or more samples from each portion can be taken. In general, the partition function can reduce the effect of presentation bias in the page where sampling more products from initial shelf page sections or pages and fewer products from later sections or pages can lead to a biased estimate of the navigational prior. Once the partition function is generated, products can be sampled within each partition, thereby leading to a stratified sample 704 of product pages from the input shelf page 702.

After sampling the subset of product pages, the product pages can be fed through the webpage content module 116 to determine categories and confidence scores for the product pages. The results from the webpage content module 116 can be processed with a throttling engine 706, to determine which results are accurate enough to be saved and which results are inaccurate and should be sent to the crowd for adjustment. For example, product pages having high confidence scores (e.g., greater than 80% or 90%) can be saved (step 708) to the webpage data 122 and flagged as having correct categories. Results for product pages with low confidence scores (e.g., less than 70% or 80%) can be manually classified (step 710) using crowd validation 712. The crowd validation results may then be saved (step 714) to the webpage data 122.

The saved results in the webpage data 122 (i.e., results from the crowd validation and high confidence score results from the webpage content module 116) can be combined together (e.g., in a re-scoring process) to estimate an initial or seed navigational prior 716. This navigational prior 716 can be referred to as the seed navigational prior since it is preferably estimated over only a subset of product pages in the shelf page 702 and not the complete set of product pages.

In some examples, the seed navigational prior X can be refined iteratively, using the re-scoring module 120. With each iteration, for example, the seed navigational prior from the previous iteration can be used to perform a Bayesian re-scoring of unclassified products on the shelf page. In this manner, the navigational prior can be updated after every iteration until all the product pages on the shelf are accurately classified. In one iterative approach, for example, the seed navigational prior is an initial guess or current estimate for the navigational prior. At each iteration, full classification can be performed using the current estimate of the navigational prior. Classification output can be verified through the crowd, and these verified category answers can be used to re-estimate a new value of navigational prior. Iterations can continue until convergence or when updates to the navigational prior become significantly smaller (e.g., less than 1% or 5%). In general, any incorrect category predictions for webpages can be identified and corrected with this process. For example, if a shelf page generally relates to shoes but one item is currently categorized as belonging to exercise equipment, the re-scoring process can identify this apparent error and/or attempt to fix the classification for the item.

In general, for the product pages associated with a shelf page, the systems and methods obtain a candidate category list from the webpage content module 116 and a probability of categories from the navigational prior module 118. A purpose of the re-scoring module 120 is to combine these two probabilities and estimate a smoother probability distribution for the shelf page and the item webpages that are accessed from the shelf page.

In preferred examples, a standard Bayesian formulation can be used to solve this problem. More specifically, for a given product page d belonging to a particular shelf page S, an output CLF(d) can be obtained from the webpage content module 116:

CLF(d)={<ci,scorei>|1≤i≤K,i∈N} (8)

where K denotes the total number of possible candidates output from the classification system and cᵢ denotes the i-th candidate and score, denotes the probability of the i-th candidate from the classification system and N denotes the set of natural numbers. A navigational prior of the shelf PRIOR(S) can be represented as:

PRIOR(S)={<cj, scorej>|1≤j≤M,j∈N} (9)

where M denotes the total number of possible categories present in the shelf S and N denotes the set of natural numbers. Given that probability of a category for a product P(c|d) and probability of a category for a shelf P(c|S) are independent, a Bayesian re-scoring can be defined as the posterior probability POSTERIOR(d|S) as:

$$\begin{matrix}POSTERIOR ( {c}_{x} \vert d , S ) = \frac{P ( {c}_{x} ⋂ d ⋂ S )}{P ( d ⋂ S )} & ( 10 ) \\ POSTERIOR ( {c}_{x} \vert d , S ) ∝ P ( {c}_{x} ⋂ d ⋂ S ) & ( 11 ) \\ POSTERIOR ( {c}_{x} \vert d , S ) ∝ P ( {c}_{x} ⋂ d ) * P ( {c}_{x} ⋂ S ) & ( 12 ) \\ POSTERIOR ( {c}_{x} \vert d , S ) ∝ P ( {c}_{x} \vert d ) * P ( {c}_{x} \vert S ) & ( 13 )\end{matrix}$$

In the above equation, P(cₓ|d) can be obtained from CLF(d) and P (cₓ|S) can be obtained from PRIOR(S). Finally, a category x is chosen as the final answer for product d which has the maximum-a-posterior probability.

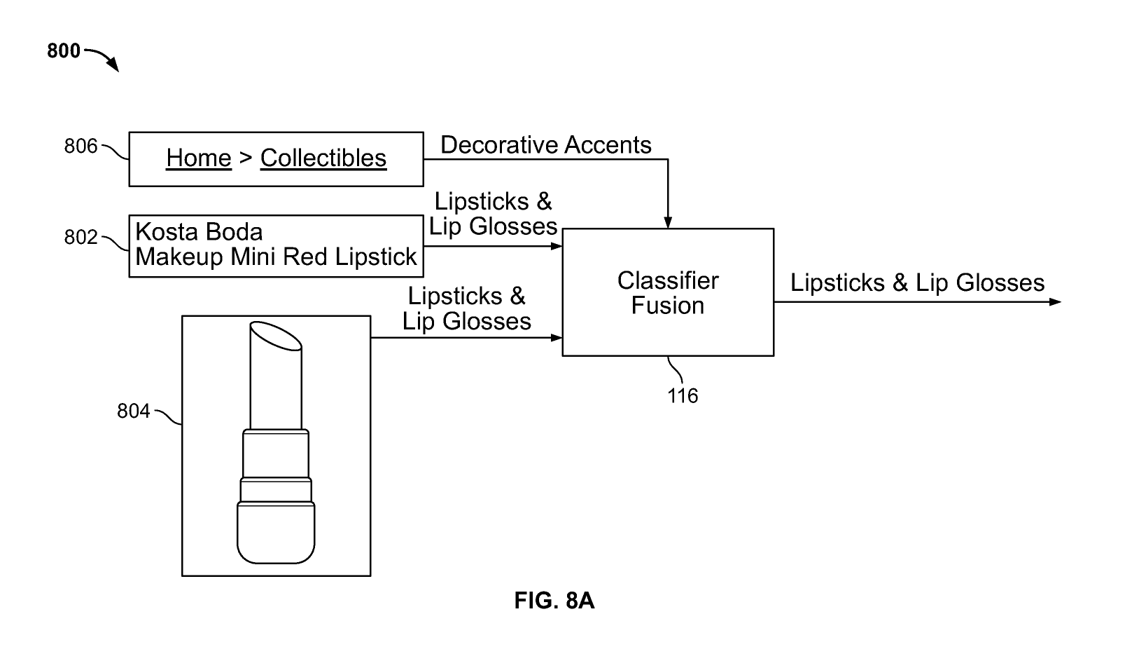

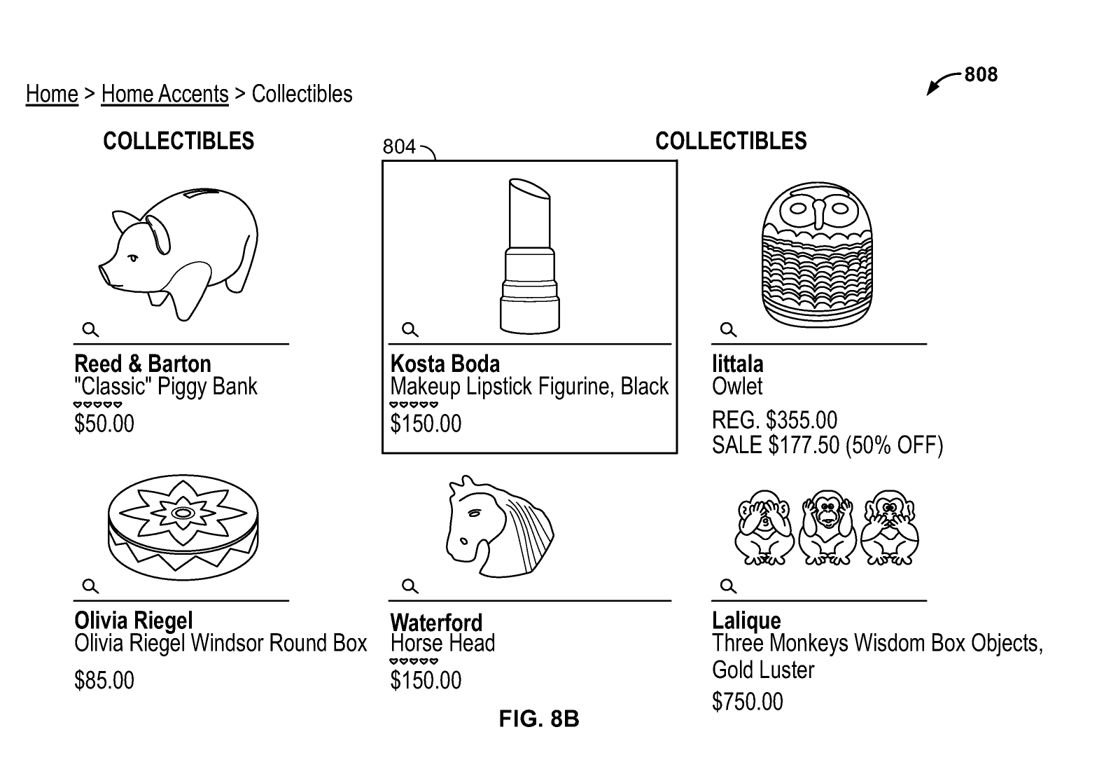

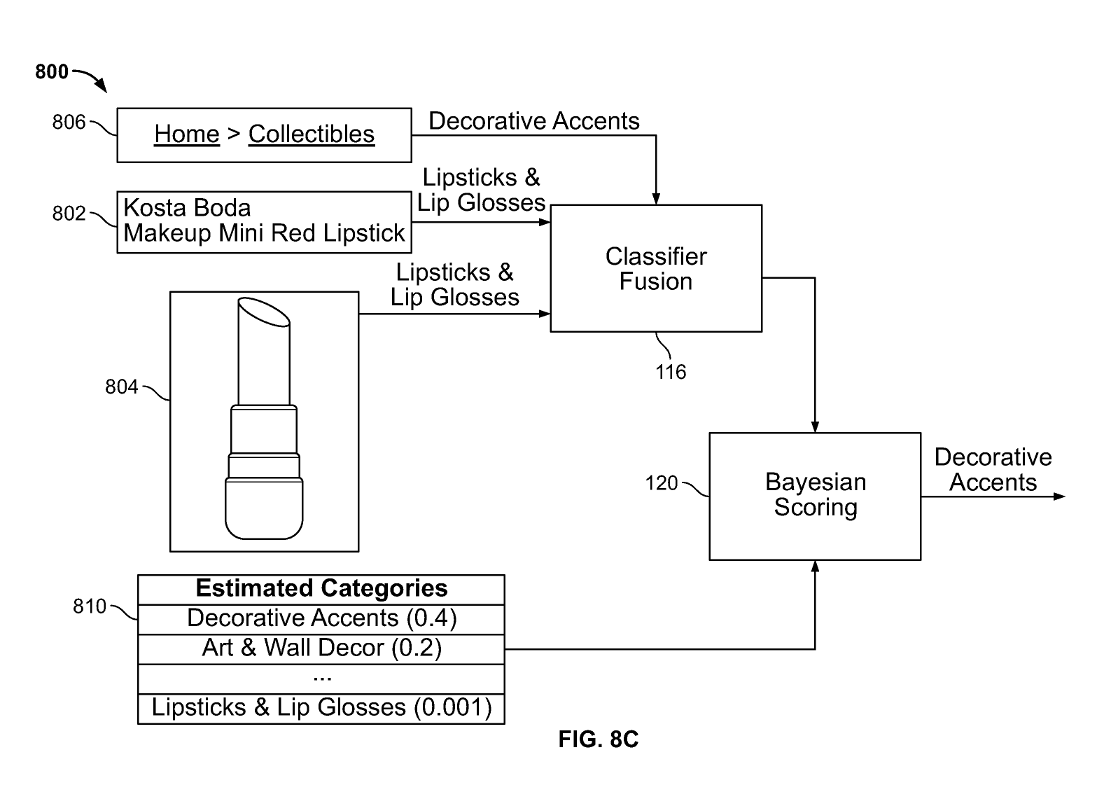

FIGS. 8A, 8B, and 8C illustrate an example method 800 in which the re-scoring module 120 can be used to improve the category prediction for an item shown and described on a webpage. The webpage in this example has a title 802 and image 804 indicating that the item is lipstick; however, the item is actually a figurine and not real lipstick. Referring to FIG. 8A, when the title 802, the image 804, and a breadcrumb 806 are input into the webpage content module 116, the webpage content module 116 can predict that the most probable category for the item is “Lipsticks & Lip Glosses.” Referring to FIG. 8B, a shelf page 808 for this item shows other items on the shelf page 808 that belong to a “Collectible” category or a “Decorative Accent” category. Referring to FIG. 8C, the navigational prior module 118 can output a navigational prior 810 indicating that most items on the shelf page 808 relate to decorations and have a 40% probability of falling into a Decorative Accents category and a 20% probability of falling into an Art & Wall Decor category. The navigational prior 810 indicates that items on the shelf page 808 have only a 0.1% probability of falling into the Lipsticks & Lip Glosses category. By combining the navigational prior 810 with output from the webpage content module 116, the re-scoring module 120 is able to identify that the correct category for the item is “Decorative Accents.” For example, the re-scoring module may recognize that “Lipsticks & Lip Glosses” is an inaccurate category prediction, given the low probability for the category in the navigational prior 810.

In various implementations, the systems and methods utilize a taxonomy that can evolve or change over time as new items are encountered and classified. For example, a new macro category can be selected and a taxonomist can study the domain for the macro category and design taxonomy trees. The taxonomy can be reviewed and tested by real world data. One implementation of a taxonomy includes 17 macro categories that contain 1591 leaf item categories. The taxonomist can annotate the training data, which can include text and images. The classifiers can be implemented using a deep learning framework (e.g., CAFFE). In some examples, the training process usually can take about 12 hours to finish.

In various instances, an integrated crowd management system can receive tasks in a weekly cycle. Whenever the classification confidence is below a certain threshold, for example, the automated system can create a task in the crowd platform. In certain examples, the task for a product can contain top five item categories from the webpage content module 116 or raw classification, along with all the item categories that are predetermined (e.g., in a navigational prior) for a parent shelf page for the product. The crowd can then choose the most fitting item category from a list and the system can use the crowd's responses to determine the final answer.

The systems and methods described herein can be implemented using a wide variety of computer systems and software architectures. In one example, the systems and methods can be implemented with three g2.xlarge machines and t2.micro machines in AMAZON WEB SERVICES (AWS) auto scaling group. In a weekly cycle, the systems and methods can ingest and classify about one millions products or more. Depending on a number of tasks received, the systems and methods can auto-scale up to 100 t2.micros machines. The number of crowd members employed can be from about 10 to about 50.

To illustrate the efficacy of the systems and methods described herein, experiments were performed on a dataset with millions of eCommerce products with varying degrees of product feed quality spread across a large combination of merchants and categories. In general, the experimental results demonstrate superior performance and good generalization capabilities of the systems and methods.

To perform the experiments, a static dataset of 1 million product pages was extracted from a diverse domain of eCommerce websites that include 33 difference merchants and about 5000 shelves. The average number of products per shelf in this sample was 213, while the average number of categories per shelf was 42. Additional information for the dataset are provided in Table 2.

TABLE 2
Statistics for dataset.

| Item | Quantity |
|---|---|
| # product pages | 1 million |
| # merchants | 33 |
| # shelf | 5058 |
| # categories | 1209 |
| average product/shelf | 213 |
| average category/shelf | 42 |

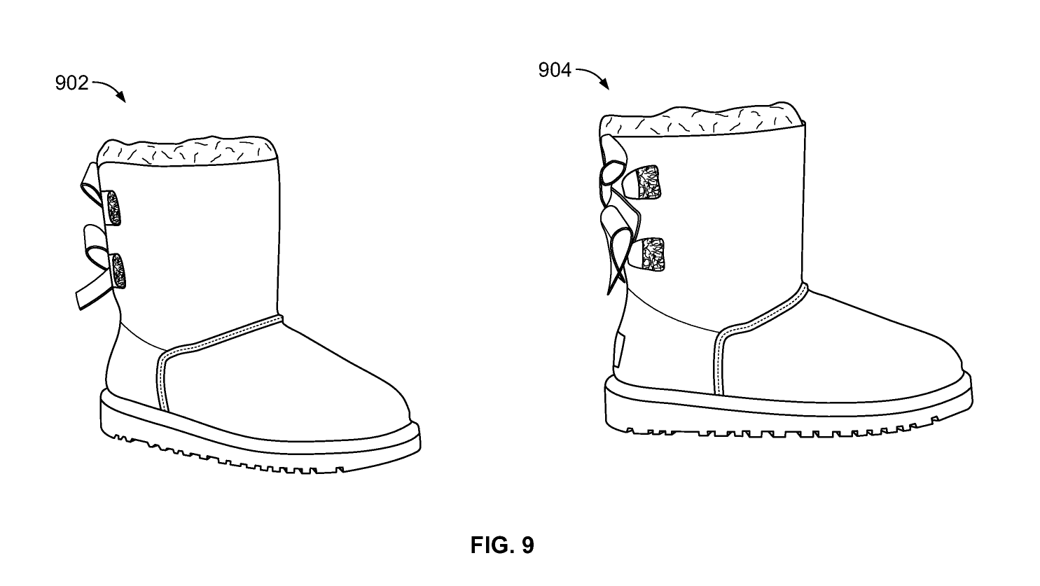

To investigate the performance of each base classifier used in the webpage content module 116, classification accuracy was computed over the dataset. As the results in Table 3 indicate, the algorithm with the best top-1 accuracy (72.3%) was the BoW text classifier, followed by the word-to-vector (with SVM) text classifier (62.0%), and the CNN image classifier (61.0%). One possible explanation for the lower performance of the image classifier is that certain items can belong in different categories but have similar images. As an example, FIG. 9 contains images from product pages for a woman's boot 902 and girl's boot 904. Given the similarities between these images, the image classifier module 206 can have difficulty recognizing that the two boots belong in different categories.

TABLE 3
Raw classifier performance.

| Algorithm | Top-5 Accuracy | Top-1 Accuracy |
|---|---|---|
| BoW | 90.39% | 72.3% |
| Word-to-Vector | 84.99% | 62.0% |
| CNN | 69.07% | 61.0% |

Table 4 contains accuracy results obtained using the classifier fusion module 208 to combine results from the BoW text classifier, the word-to-vector (with SVM) text classifier, and the CNN image classifier. The results show that use of the classifier fusion module 208 improved the accuracy by about 9%, when compared to the accuracy for the BoW text classifier alone.

The last two rows of Table 4 present accuracy results obtained using the re-scoring module 120 to refine the output from the classifier fusion module 208 and the navigational prior module 118. When the navigational prior module 118 used the unsupervised model 604, the top-1 accuracy was 83.19%. When the navigational prior module 118 used the semi-supervised model 606, the top-1 accuracy was 85.70%.

TABLE 4
Accuracy obtained with classifier fusion and re-scoring.

| Algorithm | Top-5 Accuracy | Top-1 Accuracy |
|---|---|---|
| Classifier Fusion | 96.06% | 81.11% |
| Re-Scoring Unsupervised | 96.60% | 83.19% |
| Re-Scoring Semi-supervised | 96.70% | 85.70% |

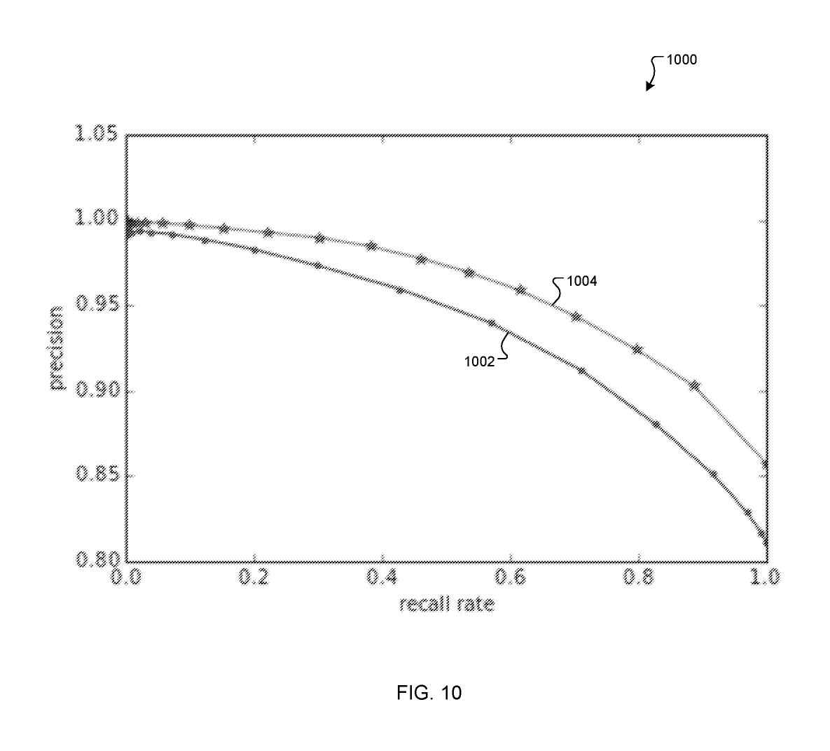

FIG. 10 is a plot 1000 of precision versus recall rate showing a comparison of unsupervised versus semi-supervised approaches to throttling (e.g., in the throttling engine 706). Results for the unsupervised approach (e.g., from the unsupervised model 604) are shown in the bottom line 1002, while results for the semi-supervised approach (e.g., from the semi-supervised model 606) are shown in the top line 1004. The results indicate that the semi-supervised algorithm can maintain a higher degree of precision even as the recall rate increases. The threshold values are not shown in the plot 1000, but each point on the lines 1002 and 1004 corresponds to one threshold. In general, the plot 1000 provides an example in which the throttling engine was defined as a threshold over the top candidate's corresponding score. The plot 1000 illustrates a tradeoff between recall rate (e.g., without going through the crowd validation) and a corresponding precision.

Classifying products from multiple merchant taxonomies to a single normalized taxonomy can be a challenging task. Many data points, available to the host or retailer merchant, may not be available when classifying products with only the information available on product pages (e.g., some merchants do not publish a breadcrumb on product pages). Product titles can have inconsistent attribute level information, such as brand, color, size, weight, etc. Data quality varies considerably across merchants, which can add to the complexity. Advantageously, the systems and methods described herein can use multiple input signals from a webpage, including title, breadcrumb, thumbnail image, and latent shelf signals. Two text classifiers, BoW and word-to-vector can be used to classify a product page using textual information, for example, from the product title and breadcrumb. A CNN classifier can be built for product image classification. Further, systems and methods are described for determining category distributions for shelf pages. Such information is useful for classifying items from a website to various categories, for example, in a hierarchical or non-hierarchical taxonomy. By using multiple modalities from a product page (e.g., text, images, and hidden shelf organizational signals), classifiers are able to work together in a complementary manner.

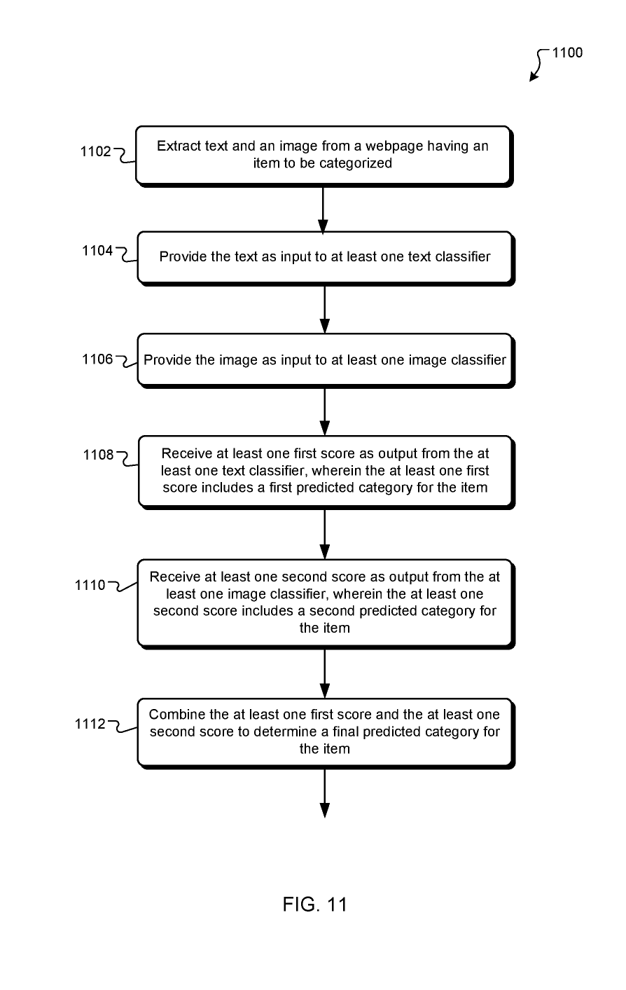

FIG. 11 is a flowchart of an example method 1100 of categorizing an item presented in a webpage. Text and an image are extracted (step 1102) from a webpage having an item to be categorized. The text is provided (step 1104) as input to at least one text classifier. The image is provided (step 1106) as input to at least one image classifier. At least one first score is received (step 1108) as output from the at least one text classifier, wherein the at least one first score includes a first predicted category for the item. At least one second score is received (step 1110) from the at least one image classifier, wherein the at least one second score includes a second predicted category for the item. The at least one first score and the at least one second score are combined (step 1112) to determine a final predicted category for the item.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a smart phone, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending webpages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
extracting text and an image from a webpage comprising an item to be categorized;
providing the text as input to at least one text classifier;
providing the image as input to at least one image classifier;
receiving at least one first score as output from the at least one text classifier, the at least one first score comprising a first predicted category for the item;
receiving at least one second score as output from the at least one image classifier, the at least one second score comprising a second predicted category for the item; and
combining the at least one first score and the at least one second score to determine a final predicted category for the item.

2. The method of claim 1, wherein the text comprises at least one of a title, a description, and a breadcrumb for the item.

3. The method of claim 1, wherein the item comprises at least one of a product, a service, a person, a place, a brand, a company, a promotion, and a product attribute.

4. The method of claim 1, wherein the at least one text classifier comprises at least one of a bag of words classifier and a word-to-vector classifier.

5. The method of claim 1, wherein the at least one image classifier comprises convolutional neural networks.

6. The method of claim 1, wherein combining the at least one first score and the at least one second score comprises:
determining weights for the at least one first score and the at least one second score; and
aggregating the at least one first score and the at least one second score using the weights.

7. The method of claim 1, further comprising:
identifying a plurality of categories for a shelf page linked to the webpage; and
determining a probability for each category in the plurality of categories, the probability comprising a likelihood that the shelf page comprises an item from the category.

8. The method of claim 7, wherein identifying the plurality of categories comprises determining a crawl graph for at least a portion of a website comprising the webpage.

9. The method of claim 7, wherein determining the probabilities comprises using at least one of an unsupervised model and a semi-supervised model.

10. The method of claim 7, further comprising:
providing the final predicted category and the probabilities as input to a re-scoring module; and
receiving from the re-scoring module an adjusted predicted category for the item.

11. A system comprising:
a data processing apparatus programmed to perform operations for categorizing online items, the operations comprising:
extracting text and an image from a webpage comprising an item to be categorized;
providing the text as input to at least one text classifier;
providing the image as input to at least one image classifier;
receiving at least one first score as output from the at least one text classifier, the at least one first score comprising a first predicted category for the item;
receiving at least one second score as output from the at least one image classifier, the at least one second score comprising a second predicted category for the item; and
combining the at least one first score and the at least one second score to determine a final predicted category for the item.

12. The system of claim 11, wherein the text comprises at least one of a title, a description, and a breadcrumb for the item.

13. The system of claim 11, wherein the item comprises at least one of a product, a service, a person, a place, a brand, a company, a promotion, and a product attribute.

14. The system of claim 11, wherein the at least one text classifier comprises at least one of a bag of words classifier and a word-to-vector classifier.

15. The system of claim 11, wherein the at least one image classifier comprises convolutional neural networks.

16. The system of claim 11, wherein combining the at least one first score and the at least one second score comprises:
determining weights for the at least one first score and the at least one second score; and
aggregating the at least one first score and the at least one second score using the weights.

17. The system of claim 11, the operations further comprising:
identifying a plurality of categories for a shelf page linked to the webpage; and
determining a probability for each category in the plurality of categories, the probability comprising a likelihood that the shelf page comprises an item from the category.

18. The system of claim 17, wherein identifying the plurality of categories comprises determining a crawl graph for at least a portion of a website comprising the webpage.

19. The system of claim 17, the operations further comprising:
providing the final predicted category and the probabilities as input to a re-scoring module; and
receiving from the re-scoring module an adjusted predicted category for the item.

20. A non-transitory computer storage medium having instructions stored thereon that, when executed by data processing apparatus, cause the data processing apparatus to perform operations for categorizing online items, the operations comprising:
extracting text and an image from a webpage comprising an item to be categorized;
providing the text as input to at least one text classifier;
providing the image as input to at least one image classifier;
receiving at least one first score as output from the at least one text classifier, the at least one first score comprising a first predicted category for the item;
receiving at least one second score as output from the at least one image classifier, the at least one second score comprising a second predicted category for the item; and
combining the at least one first score and the at least one second score to determine a final predicted category for the item.
